(19) United States
(12) Patent Application Publication
(10) Pub. No.: US 2003/0025300 A1
(43) Pub. Date: Feb. 6, 2003

(54) Stroller

(76) Inventor: Peter Maxisch, Paderborn (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/191,146

(22) Filed: Jul. 8, 2002

(30) Foreign Application Priority Data
Aug. 1, 2001 (DE) 20112583.8

(51) Int. Cl. B62B 7/06

(52) U.S. Cl. 280/642

(57) ABSTRACT

A stroller having a chassis, wheels on said chassis, a handle, an adjustable footrest and a backrest. At least the backrest can be pivoted by means of an actuating drive which has a rotatable drive element.

### FIELD

This invention relates to a stroller having a chassis, wheels on said chassis, a handle, an adjustable footrest and a backrest.

### RELATED ART

Strollers are known in a large number of configurations. In known strollers, the chassis is provided with two lateral scissor arrangements which make it possible for the overall height to be reduced to a considerable extent in order for the stroller to be transported in a space-saving manner when not in use. Coupled to these two scissor frameworks are two wheel axles which run transversely to the scissor frameworks and which have wheels mounted at their end regions. Locking the scissor frameworks in the erected state is done by locking means associated with the handle. The footrest can be pivoted about a horizontal axis and the angle of inclination can be adjusted by means of a pivotable clip.

In such known strollers, the scissor arms of the scissor frameworks and, as appropriate, also pivotable clips are attached by rivet connections, which involve extremely high cost. These strollers have proven highly successful in practice. Even in the collapsed state, a relatively large amount of space is still required. Although, in general, customers have not found this to be a problem, there are motor vehicles such as sports cars, which are provided with a trunk of relatively small volume.

### SUMMARY OF THE INVENTION

An object of the invention is to configure a stroller of the type described above so that it can be collapsed in a space-saving manner in order to be transported in the empty state, and that, in particular, it is also possible to dispense with the high-outlay rivet connections.

This object is achieved in that at least the backrest of the stroller can be pivoted by means of an actuating drive which has a rotatable drive element.

In a preferred embodiment, the backrest and the footrest can each be pivoted by means of an actuating drive, and each actuating drive has a rotatable drive element. The actuating drives are preferably of the same structural configuration. An example of a possible drive element is a handwheel. Such actuating drives make it possible for the pivoting range of the backrest and, if appropriate, also of the footrest to be of such a magnitude that it is possible for them not just to be pivoted into the position which is optimum for the child lying or sitting in the stroller, but also to conform, when the stroller is not in use, to the configuration of the collapsed stroller, thereby reducing the amount of storage space required. Actuating drives of this type make handling extremely straightforward since all that is required is for the drive element to be rotated. These actuating drives make it possible for the backrest to be pivoted from the normal, sloping position into an opposite, i.e. a downward-hanging, position.

Each actuating drive may have at least two bars having their axes parallel to each other and extending substantially over the width of the backrest or of the footrest. The drive element is positioned at one end of one of the bars. The bars of each actuating drive are coupled via interengaging pinions, the output-side pinion engaging with a toothed segment secured on the backrest or on the footrest. Accordingly, the bar provided with the drive element forms the input member or driving member of the actuating drive. The bar running parallel thereto acts as a transmission bar carrying at least one pinion which engages with a corresponding toothed segment, such pinion being the output member. Alternatively, each actuating drive may have just one drive bar which extends over the width of the backrest and/or of the footrest, the driving element being positioned in a rotationally fixed manner at one end, and an output pinion being secured thereon to engage with a toothed segment. If each actuating drive is provided with two bars, it is advantageous for the interengaging pinions on the two bars to form a gear train in order to increase the adjustment speed of the backrest and, if appropriate, also of the footrest. For this purpose, the number of teeth of the pinion which is secured on the driving element is larger than that of the pinion engaging therewith. The higher adjustment speed is not important for the optimum adjustment of the backrest and/or of the footrest when a child is sitting or lying in the stroller, but it is advantageous when the stroller is to be moved into the collapsed position.

When the stroller is in use, the position of the backrest depends on whether the child is sleeping or awake. When the child is sleeping, the backrest is pivoted into a relatively flat position, i.e. the angle enclosed in relation to the horizontal is considerably smaller than when the child is awake. In order that the child is secured against falling out of the stroller when the backrest is positioned for the child to sleep, at least the border region which is directed away from the footrest is provided with a protective element. This protective element forms a raised border all the way round, but would be in the way if the backrest is pivoted into an upright position when the child is awake. It is thus provided that the protective element can be pivoted into the functional position by means of an erecting mechanism when a predetermined angle is reached. For this purpose, it is expedient if the protective element has a bracket which is mounted on the backrest such that it can be pivoted about a stationary axis, and if this bracket can be pivoted by means of a slide. The erecting mechanism is designed such that the backrest itself acts as a drive element in that, when the angle of slope drops below a certain value, the bracket is pivoted counter to the movement of the backrest. Fabric or netting is also fastened to the bracket and to the backrest, with the result that the protective element is continuous.

Throughout the period of time over which a child travels in the stroller of this type, he/she grows considerably. In order that it is not just the legs which are supported by means of the footrest, provision is made for the footrest to be provided with an adjustable angled support. The spacing between said angled support and the free edge of the footrest may be adjusted in dependence on the child's height, with the result that the child can support himself/herself on the angled support using his/her feet. It would be possible to change the spacings to the free edge of the footrest in relatively small steps, for example by a latching grid, which is designed such that no tools or any kind of mechanical elements are necessary for adjustment purposes.

In order for it to be possible for the stroller to be conveniently pushed and, if appropriate, also pulled, it is provided that the free ends of the handle engage in a swivel plate mounted rotatably on side parts of the stroller, and that the handle engages in latching elements in different angular positions. The handle can then be adjusted optimally to the height of the person pushing the stroller. In contrast to the scissor frameworks which have been known up until now, the side parts are panel-like and have a non-changeable configuration. The swivel plates are guided in a form-fitting manner in corresponding circular recesses. Latching bores, for example, are functionally assigned to the swivel plates and have journals, which can be adjusted in a longitudinal direction of the handle, engaging in them. In order to adjust the handle, these journals are disengaged from the bores. In contrast to the configurations which have been known up until now, it is possible for the handle not just to be pivoted, but also to be displaced in its longitudinal direction in relation to the swivel plates. In a preferred configuration, the handle can be displaced in the longitudinal direction if it has previously been moved into a position located substantially perpendicular to the floor. It can then be displaced to the extent where the free ends are level with the wheels.

The seat or recliner part, on which the backrest and the footrest are mounted, is an inherently rigid structure. Since the scissor frameworks are dispensed with, a further configuration provides that the wheels are mounted on individual arms, the individual arms being pivotally mounted on the seat and recliner body. There is then no need for wheel axles. The individual arms are arranged so that, in the operating state of the stroller, the front and rear wheels are spaced apart sufficiently from one another. In order for it to be possible for the stroller to be transported in as space-saving a manner as possible, the front and rear individual arms are moved toward one another in opposite directions, with the result that the length of the stroller is reduced to a considerable extent. The front and rear wheels are in contact with one another in this position. It is also possible for the footrest and the backrest to be pivoted into a hanging position, thus producing an extremely compact assembly for transporting the stroller in the unoccupied state. In a preferred embodiment, the individual arms are coupled to one another via a securing linkage such that the levers project beyond a dead center in order to secure the position of the wheels. The levers can be secured in this position by springs. In order to collapse the individual arms, it is provided that the securing linkage can be moved beyond the dead center in the opposite direction by means of a lever, and that the levers of the securing linkage are spring-loaded such that, once the dead center has been passed, the individual arms are moved toward one another. This facilitates the handling for collapsing the stroller chassis. Each individual arm may be formed from at least two bars so that, when the individual arms are pivoted outwardly, the wheel axis is substantially parallel to the floor. Furthermore, the wheels may be mounted on the individual arms by means of links. The wheels may be arranged in pairs on each individual arm. In order that the stroller can easily be steered, at least the front wheels, i.e. those furthest from the handle, may be mounted for angular movement about a substantially vertical axis.

### BRIEF DESCRIPTION OF THE DRAWINGS

FIG. 1 is a side view of a stroller in accordance with the invention, in the travel position,

FIG. 2 is a side view of the stroller of FIG. 1 in an intermediate position,

FIG. 3is a side view of the stroller of FIG. 1 in the collapsed position,

FIG. 4is a perspective view of the backrest of the stroller of FIG. 1, and

FIG. 5is a view from beneath of the stroller in the travel position.

### DETAILED DESCRIPTION OF THE PREFERRED EMBODIMENT

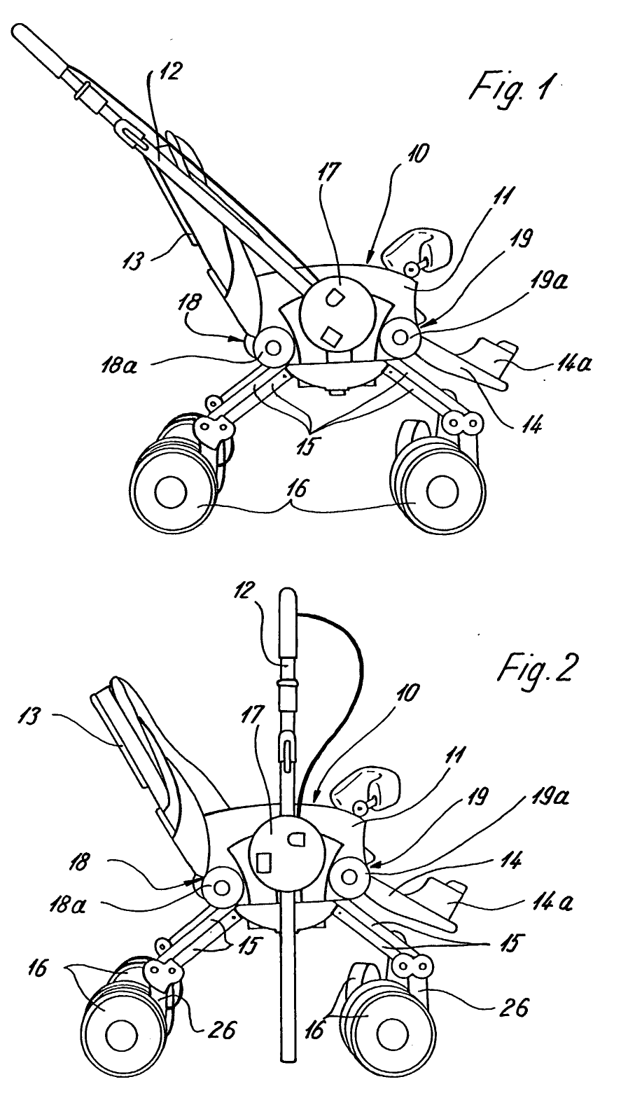

FIG. 1 shows a stroller 10 comprising a seat and recliner body 11, forming a rigid molding, a handle 12, a backrest 13, a footrest 14 and an chassis, which has four individual arms 15 and wheels 16 mounted at the free ends of the individual arms 15. Swivel plates 17 are guided in a rotatable manner on the outer sides of the two side parts of the seat and recliner body 11, the side parts of which are provided with corresponding recesses for this purpose. Two parallel side members of the handle 12 engage in corresponding bores of the swivel plates 17. Mounted in the free end regions of these parallel side members are arresting pins (not shown), which can be displaced in the longitudinal direction of the side members. These arresting pins engage in bores (not shown) which are provided in side parts of the seat and recliner body 11, adjacent to the swivel plates 17. Accordingly, the handle 12 can be secured in different angular positions. Moreover, the swivel plates 17 and the side parts are configured so that the parallel side members of the handle 12 can be pushed as far as the floor, as shown in FIG. 2, in order to collapse the stroller 10.

The backrest 13 can be pivoted via an actuating drive 18, which will be explained in more detail. For this purpose, the actuating drive 18 is provided with a drive element 18a, which in the embodiment illustrated, is a handwheel. The footrest 14 can be adjusted via a further actuating drive 19 which is preferably of the same structural configuration, this actuating drive also being provided with a drive element 19a in the form of a handwheel. Instead of the handwheels 18a, 19a, it would also be possible for the actuating drive to be provided with an electric drive.

As FIG. 1 shows, each individual arm 15 comprises two tubes which are connected to one another by a central crosspiece. The wheels 16 are fitted in pairs at the free ends of the four individual arms 15. At least the front wheels 16, which are at the opposite end of the chassis to the handle 12, are designed as steerable rollers, in order to make it easier for the stroller 10 to be moved along a curved path.

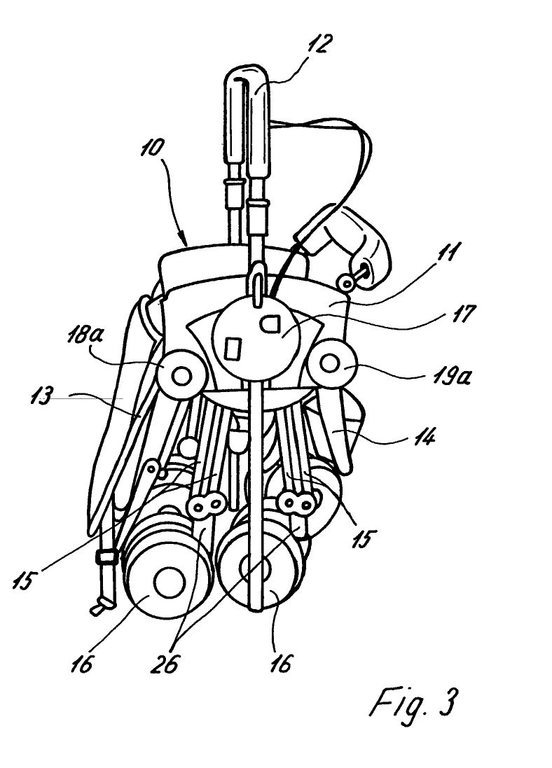

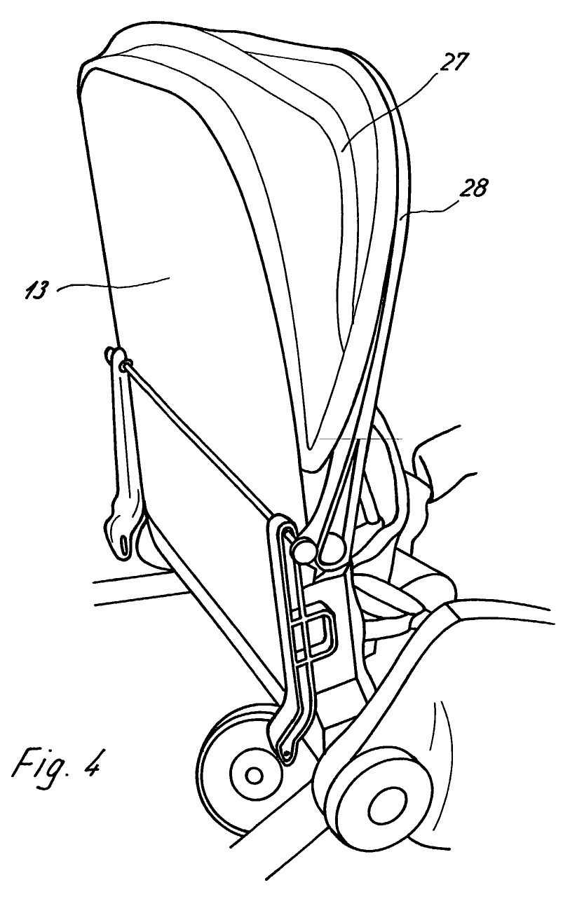

In order to collapse the stroller 10 as shown in FIG. 3, first of all the handle 12 is pushed into the position illustrated in FIG. 2. The front and rear wheels 16 come into contact with one another or are spaced apart from one another to a small extent. Thereafter, the backrest 13 and the footrest 14 can be lowered by means of the actuating drives 18, 19, with the result that they are adjacent to the individual arms 15. This forms a space-saving assembly, as FIG. 3 shows.

As FIG. 5 shows, those ends of the arms 15, which are connected to the left-hand side of the seat and recliner body 11 are coupled to one another by a securing linkage 20. The arms 15 on right-hand side are also coupled by a similar securing linkage 20. Each securing linkage 20 essentially comprises levers which are connected to one another in an articulated manner. From a kinematic point of view, each securing linkage 20 is designed such that, in the travel position illustrated in FIG. 5, the levers are drawn beyond the dead center position in order to secure the individual arms 15 in the position illustrated in FIG. 1. In order to collapse the individual arms 15, the levers of the securing linkage 20 are pivoted past the dead center. The individual arms 15 are then moved toward one another by tension springs 21, with the result that, once the dead center has been passed, the collapse of the stroller 10 takes place automatically without any manual force being applied. The securing linkages 20 are coupled to one another kinematically. As a result, the wheels 16 of the left-hand and right-hand sides are moved synchronously when the stroller chassis is collapsed. The act of extending the individual arms takes place in the opposite direction, for which purpose manual force has to be applied.

FIG. 5 also shows the actuating drives 18 and 19. Each actuating drive 18, 19 comprises two parallel and spaced-apart bars or rods 22, 23 which are coupled to one another via two pinions 24, 25. The two drive elements 18, 19 are positioned in a rotationally fixed manner on respective bars 22. The drive elements 18a, 19a are located laterally on a side part of the seat and recliner body 11. The pinions 25 engage with toothed segments (not shown) on the backrest 13 and respectively. The two pinions 24, 25 form a gear train such that the adjustment speed of the and/or of the footrest 14 is increased. For this purpose, the number of teeth of the pinions 24 is greater than that of the pinions 25. In the drawing, the pinions 24, 25 are shown in the center of the backrest 13 and of the footrest 14. In contrast to the drawing, it would also be possible for pinions to be positioned in the end regions of the bars 22, 23.

Pairs of wheels 16 are fitted at the free ends of the individual arms 15 via links 26.

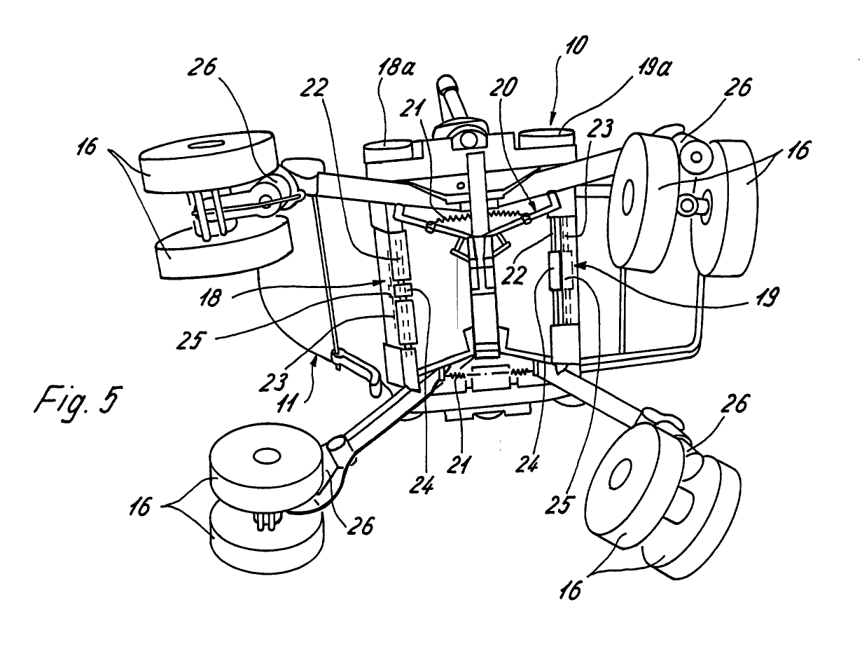

FIG. 4 shows that the backrest 13 carries a protective element 27 which erects itself automatically. For this purpose, it is mounted such that it can be pivoted about a horizontal axis and it is provided with a rigid bracket 28. The protective element 27, moreover, includes flexible netting, which is secured to the backrest 13 and to a bracket 28. As a result, the child accommodated in the seat and recliner body 11 is secured against falling out. The protective element 27 is designed such that it erects itself automatically at a certain angle of inclination of the backrest 13. This makes it possible to provide optimum protection for the child, since it is not possible for the erecting operation to be accidentally forgotten. The protective element 27 comes into operation, in particular, when the backrest 13 is moved into a sleeping position.

As FIGS. 1 and 2 show, the footrest 14 is also provided with an adjustable angled support 14a. This angled support 14a is adjusted to the child's height, with the result that he/she is also supported by his/her feet.

The invention is not restricted to the exemplary embodiment illustrated. It is essential for the backrest 13 and the footrest 14 to be adjustable in a stepless manner, over an extremely large adjustment range, via the actuating drives 18, 19, with the result that, with the chassis, formed from the individual arms 15 and the wheels 16, in the collapsed state, they can be pivoted such that they are located adjacent to the individual arms 15. It is also essential, in order to avoid rivet connections, for the chassis to have the individual arms 15.

1. A stroller having a chassis, wheels on said chassis, a handle, an adjustable footrest and a backrest, wherein at least the backrest is pivotable by means of an actuating drive having a rotatable drive element.

2. A stroller as claimed in claim 1, wherein the backrest and the footrest are each pivoted by means of an actuating drive, and each actuating drive has a rotatable drive element.

3. A stroller as claimed in claim 1, wherein the drive element has a manually rotatable handwheel.

4. A stroller as claimed in claim 1, wherein each actuating drive has at least one bar which extends over the width of the backrest and has the drive element is positioned at one end in a rotationally fixed manner, and wherein a pinion is positioned on said bar.

5. A stroller as claimed in claim 4, wherein each actuating drive has at least two bars having their axes parallel to each other and extending substantially over the width of the backrest, wherein the drive element is positioned at one end of one of the bars, and wherein the bars are coupled to one another via interengaging pinions, and wherein each output-side pinion engages with a toothed segment secured on the backrest.

6. A stroller as claimed in claim 5, wherein the pinions form a gear train in order to increase the adjustment speed of the backrest.

7. A stroller as claimed in claim 1, wherein at least that border region of the backrest which is directed away from the footrest is provided with a protective element.

8. A stroller as claimed in claim 7, wherein an erecting mechanism is arranged to erect the protective element when the backrest reaches a predetermined angle of inclination.

9. A stroller as claimed in claim 7, wherein the protective element has a bracket which is mounted on the backrest for pivotal movement about a stationary axis and wherein the bracket is erectable by means of a slide.

10. A stroller as claimed in claim 9, wherein the protective element has flexible netting which is secured to the bracket and to the backrest.

11. A stroller as claimed in claim 1, wherein the footrest is provided with an adjustable angled support.

12. A stroller as claimed in claim 1, wherein the free ends of the parallel side members of the handle engage in a swivel plate mounted rotatably on side parts of the seat and recliner body, and wherein the handle can be secured in a plurality of different angular positions in relation to the seat and recliner body.

13. A stroller as claimed in claim 12, wherein the side parts of the seat and recliner body are of panel-like design, and wherein the swivel plates are guided in a form-fitting manner in recesses.

14. A stroller as claimed in claim 1, wherein the wheels are mounted on individual arms, and wherein the individual arms are secured on the seat and recliner body by means of links.

15. A stroller as claimed in claim 14, wherein the individual arms on each side of the body are coupled to one another via a securing linkage such that the levers forming the securing linkage are guided beyond a dead center in order to secure the traveling position of the individual arms.

16. A stroller as claimed in claim 15, wherein, in order to collapse the individual arms, the securing linkage is moveable beyond the dead center by means of a lever, each of said levers being subjected to loading by a respective tension spring so that, once the dead center has been passed, the individual arms are automatically moved toward one another.

17. A stroller as claimed in claim 1, wherein each individual arm is formed from at least two bars so that, when the individual arms are pivoted, the axes of rotation of the wheels are located substantially parallel to the floor.

18. A stroller as claimed in claim 1, wherein the wheels are mounted, preferably in pairs, on the individual arms by means of links.

19. A stroller as claimed in claim 18 wherein a respective pair of wheels is mounted on each individual arm.

20. A stroller as claimed in claim 1, wherein at least the wheels, furthest from the handle are mounted for pivotal movement about vertical axes.
